(19) United States
(12) Patent Application Publication
(10) Pub. No.: US 2021/0059249 A1
(43) Pub. Date: Mar. 4, 2021

(54) ORGANIC WEED REMOVER

(71) Applicant: Humic Growth Solutions, Inc., Jacksonville, FL (US)

(72) Inventor: Kevin Merritt, St. Augustine, FL (US)

(73) Assignee: Humic Growth Solutions, Inc., Jacksonville, FL (US)

(21) Appl. No.: 16/555,448

(22) Filed: Aug. 29, 2019

(51) Int. Cl. A01N 37/02; A01N 25/30

(52) U.S. Cl. CPC A01N 37/02; A01N 25/30

(57) ABSTRACT

Aqueous liquid herbicide products include liquid fractions of water, acetic acid, fulvic acid, and a surfactant, and optionally citric acid. Salt is also dispersed in the liquid fractions to provide complete products which may be in the form of ready-to-use or dilutable concentrate herbicides. The herbicides may be directly applied to growing plants in order to quickly and effectively kill the plants.

### BACKGROUND OF THE INVENTION

### Field of the Invention

The present invention is broadly concerned with liquid herbicides containing a liquid fraction including water, acetic acid, fulvic acid, and surfactant. More particularly, the invention is concerned with such herbicides, both in ready-to-use and dilutable concentrate forms, which provide non-specific herbicidal activity. The invention also embraces methods of preparing such liquid herbicide compositions, and uses thereof.

### Description of the Prior Art

Herbicides have been used for centuries in an effort to control unwanted weeds or other invasive plants. Such herbicides can be selective, i.e., designed to kill specific classes of plants while leaving crops unharmed. Other types of herbicides are non-selective, meaning that they kill all types of vegetation.

Perhaps the most well-known selective herbicide is glyphosate, the active ingredient in Roundup®, which has achieved widespread agricultural use. However, glyphosate has been reported to be toxic to fish, birds, beneficial insects, and soil organisms. Indeed, there are worldwide efforts to eliminate or reduce widespread glyphosate usage.

Efforts have also been made to develop more natural or organic herbicides which have minimal adverse ecological consequences. For example, homeowners or small commercial growers have been known to use vinegar as a herbicide, because the acetic acid content of vinegar has proven to be an effective non-selective herbicide.

In addition, it is known to provide herbicide compositions made up of vinegar and lemon juice, relying upon the acetic acid content of vinegar with the citric acid content of lemon juice to give synergistic compositions. See U.S. Pat. No. 5,705,455.

Continuing efforts are underway to develop even more effective herbicides using commonly available ingredients, particularly towards certifiably organic herbicide products.

Humic and fulvic acids are well-known soil-derived products which have found agricultural uses. In general, humic acids are relatively large molecules ranging in molecular weight from about 10,000-100,000. The exact composition of humic acids depends upon the source thereof. However, all humic acids are insoluble in acidic water, but can be dissolved in alkaline solutions. Humic acids mediate essential exchanges between plants and soil.

Fulvic acids are much smaller molecules than humic acid, and range in molecular size from about 1,000-10,000. Fulvic acids are also soluble in water at all pH levels. There are two general types of fulvic acids, namely fulvates bound to minerals, and free-form fulvic acid. They are golden in color and more biologically active than humic acids owing to the fact that the oxygen content of fulvic acids is nearly twice that of humic acids. The principal benefit of fulvic acids is their ability to bind to nutrients and facilitate nutrient uptake into plants.

### SUMMARY OF THE INVENTION

The present invention provides significantly improved weed removers/herbicides which include a liquid fraction comprising (or consist essentially of, or consisting of) water, acetic acid (usually though not necessarily derived from vinegar), fulvic acid, and surfactant (nonionic, anionic, cationic, amphoteric, and mixtures thereof). In preferred forms, the products of the invention also include minor amounts of citric acid and salt (sodium chloride) dispersed in the liquid fraction of the herbicide. The presence of fulvic acid greatly enhances the herbicidal activities of the products of the invention. These products may be prepared as ready-to-use herbicides or as concentrates which may be diluted with water prior to application thereof.

The ready-to-use products of the invention are sprayed or otherwise applied onto growing plants, specifically to the leaves and/or stems thereof; alternately, the products may be applied to the soil adjacent growing plants. This results in rapid and essentially complete elimination of the treated plants over a very short period, e.g., from about 1-7 days.

Although not essential to the invention, if it is desired to make certifiably organic herbicide products, the vinegar/acetic acid, citric acid, and salt would be Kosher grade materials.

### DETAILED DESCRIPTION OF THE PREFERRED EMBODIMENTS

In general, one class of products of the invention may be characterized as ready-to-use dilutions, which can be directly applied to vegetation by a user. Another product class would be dilutable concentrates, which would need to be diluted with water prior to use thereof.

Turning first to the ready-to-use products, these comprise a liquid fraction having appropriate quantities of water, surfactant, acetic acid, and fulvic acid, with added salt. In particularly preferred forms, a minor amount of citric acid also forms a part of the liquid fraction. In terms of amounts, these liquid fractions would typically contain from about 60-90% (preferably from about 65-85%) water, 1-8% (preferably from about 3-7%) surfactant (preferably nonionic surfactant), 10-25% (preferably from about 12-20%) acetic acid, and 0.2-1.5% (preferably from about 0.4-0.9%) fulvic acid; where citric acid is employed, the use levels would normally range from about 0.1-0.7% (preferably from about 0.2-0.4%). All of the foregoing percentages are volumetric (v/v). The amount of salt added to the liquid fraction would generally be from about 0.005-5% (preferably from about 0.075-3.5%) by weight salt, based upon the total weight of the ready-to-use liquid fraction taken as 100% by weight.

The concentrates of the invention would also be made up of liquid fractions with added salt. Generally, the amounts of the ingredients in the concentrates are related to those of the ready-to-use products, except that a significant amount of water (e.g., 50% by volume) would be eliminated. Thus, the concentrate liquid fractions would include from about 28-45% (preferably from about 35-43%) water, from about 9-18% (preferably from about 10-15%) surfactant, from about 35-60% (preferably from about 40-55%) acetic acid, from about 1-4% (preferably from about 1.4-3%) fulvic acid; where citric acid is present, the use levels would range from about 0.3-3% (preferably from about 0.5-1.5%). Again, all the foregoing percentages are volumetric (v/v). In the concentrates, salt would be present at a level of from about 0.02-7.5% (preferably from 0.4-5%) by weight salt, based upon the total weight of the concentrate liquid fraction taken as 100% by weight.

These products, either ready-to-use or concentrates, may be prepared as dispersions, emulsions, solutions, or in any other desired flowable liquid form.

In preparing the products of the invention, both ready-to-use and concentrates, humic raw material powder is first mixed with an excess of hot water (150-250° F., more preferably from about 175-225° F.), along with Kosher vinegar and Kosher acetic acid powder. This mixture is then mechanically blended for a period of from about 8-24 hours (more preferably from about 10-15 hours) to give an intermediate product having an acidic pH (preferably from about 1.5-6, more preferably from about 2.5-4). The blended mixture is then screened to separate out a substantial fraction of the humic, humin, ash, clay, and silt solids, whereupon the screened liquid is placed in a settling tank for a period of 5-30 days (more preferably from about 10-18 days). This settling causes the lower molecular weight organic acid species to rise to the top of the tank, whereas the heavier molecular weight fulvic acid species descend towards the bottom of the tank. This high molecular weight bottoms fraction is then siphoned from the tank and is subjected to a reverse osmosis process over a period of from about 2-12 hours (more preferably from about 6-10 hours), giving a fulvic acid concentrate usually containing from about 3-9% (more preferably from about 4.5-7.5%) fulvic acid by volume; the particle size of the fulvic acid ranges from about 500-10,000 Daltons. The reverse osmosis involves filtering the bottoms fraction through successive, smaller orifice stages (e.g., 3-10 micron, 0.5-3 micron, and less than 1 micron). The lower molecular weight organic acid fraction from the settling step contains respective amounts of acetic acid, citric acid, and residual fulvic acid, typically in approximately equal amounts.

The organic acid fraction and the fulvic acid concentrate are then blended, followed by the addition of from about 4-9 ounces (more preferably from about 5.5-7 ounces) of surfactant, in order to complete the liquid fraction of the final product. As noted, the surfactant is preferably nonionic, and may be a polyether polyol such as Tergitol L-62®. Other nonionic surfactants having covalently bonded oxygen-containing hydrophilic groups may be used, such as fatty alcohol ethoxylates, ethoxylated amines, fatty acid amides, terminally blocked ethoxylates, fatty esters of polyhydroxy compounds (e.g., glycerol), fatty acid esters of sorbitol and sucrose, alkyl polyglucosides, amine oxides, sulfoxides, and phosphine oxides.

In the final preparative step, Kosher salt is added to the liquid fraction by a simple blending operation.

The following example sets forth preferred procedures for production of a ready-to-use organic herbicide. It should be understood that this example is provided by way of illustration only, and nothing therein should be taken as a limitation on the overall scope of the invention.

### EXAMPLE

An exemplary, ready-to-use organic herbicidal composition in accordance with the invention includes a liquid fraction with a quantity of salt dispersed in the liquid fraction. Specifically, the liquid fraction contains 55% of 300 grain (30%) acetic acid, 5% nonionic surfactant, 5% fulvic acid concentrate, and 35% organic acid mixture, where all percentages are based on volume (v/v). The final ready-to-use composition, including added salt, is a clear dispersion with a pH of from about 1.5-5, more preferably from about 2.5-4, and most preferably about 3.2.

In the first step, 8,000 lbs of humic raw material are added to 2,898 gal of heated water (180-190° F.), along with 275 gal of Kosher 30% vinegar and 350 lbs of Kosher citric acid powder. This mixture is then blended for a period of 12 hours, and has a resultant pH of approximately 3. The blended mixture is then screened through 400 mesh screens to separate out humic, humin, ash, clay, and silt. The screened liquid is then placed in a settling tank for 14 days. This causes the lighter molecular weight organic species to rise to the top of the tank, while the heavier molecular weight fulvic acid species descend to the tank bottom.

Next, the higher molecular weight bottoms fraction is siphoned from the tank and run through an 8-hour reverse osmosis process where it is filtered in three stages, through 5 micron, 1 micron, and less than 1 micron filters. This yields a 6% fulvic acid concentrate fraction and a 35% purified organic acid fraction containing approximately equal amounts of acetic acid, citric acid, and residual fulvic acid; the particle size of the fulvic acid in this concentrate is approximately 600 Daltons. The fulvic acid concentrate and purified organic fraction are blended, followed by the addition of 6.4 ounces of Tergitol L-62® liquid nonionic polyether polyol surfactant and 176 g of Kosher food grade salt is added to this blend. Final mixing produces the desired composition.

While the foregoing example provides an organic product, a non-organic substitute can readily be provided by the use of standard, non-Kosher acetic acid, citric acid, and salt.

I claim:

1. A ready-to-use liquid herbicide, comprising a liquid fraction including water, acetic acid, fulvic acid, and a surfactant.

2. The ready-to-use herbicide of claim 1, said liquid fraction further including citric acid.

3. The ready-to-use herbicide of claim 1, said liquid fraction surfactant being a nonionic surfactant.

4. The ready-to-use herbicide of claim 1, said water being present at a level of from about 60-90% by volume in said liquid fraction.

5. The ready-to-use herbicide of claim 1, said acetic acid being present at a level of from about 10-25% by volume in said liquid fraction.

6. The ready-to-use herbicide of claim 1, said fulvic acid being present at a level of from about 0.2-1.5% by volume in said liquid fraction.

7. The ready-to-use herbicide of claim 1, including citric acid present at a level of from about 0.1-0.7% by volume in said liquid fraction.

8. The ready-to-use herbicide of claim 1, including an amount of sodium chloride dissolved in said liquid fraction.

9. The ready-to-use herbicide of claim 8, said sodium chloride being present at a level of from about 0.005-5% by weight salt, based upon the total weight of the ready-to-use liquid fraction taken as 100% by weight.

10. The ready-to-use herbicide of claim 1, said acetic acid derived from vinegar.

11. The ready-to-use herbicide of claim 1, said herbicide having a pH of from about 1-5.

12. A dilutable liquid herbicide concentrate, said concentrate comprising a liquid fraction including water, acetic acid, fulvic acid, and a surfactant.

13. The herbicide concentrate of claim 12, said concentrate liquid fraction further including citric acid.

14. The herbicide concentrate of claim 12, said concentrate liquid fraction surfactant being a nonionic surfactant.

15. The herbicide concentrate of claim 12, said water being present at a level of from about 28-45% by volume in said concentrate liquid fraction.

16. The herbicide concentrate of claim 12, said acetic acid being present at a level of from about 35-60% by volume in said concentrate liquid fraction.

17. The herbicide concentrate of claim 12, said fulvic acid being present at a level of from about 1-4% by volume in said concentrate liquid fraction.

18. The herbicide concentrate of claim 12, including citric acid present at a level of from about 0.3-3% by volume in said concentrate liquid fraction.

19. The herbicide concentrate of claim 12, including an amount of sodium chloride dissolved in said concentrate liquid fraction.

20. The herbicide concentrate of claim 19, said sodium chloride being present at a level of from about 0.02-7.5% by weight salt, based upon the total weight of the concentrate liquid fraction taken as 100% by weight.

21. The herbicide concentrate of claim 1, said acetic acid derived from vinegar.

22. A method of preparing a liquid herbicide composition, comprising the steps of:
mixing humic raw material powder with an excess of hot water at a temperature of from about 150-250° F., and respective quantities of vinegar and acetic acid powder to create a mixture;
mechanically blending said mixture for a period of from about 8-24 hours to yield an intermediate product having an acidic pH;
screening said intermediate product to remove humic acid, humin, ash, clay, and silt solids;
placing said screened intermediate product in a settling tank for a period of from about 5-30 days, and causing lower molecular weight species to rise to the top of said tank, with heavier molecular weight fulvic acid species descending towards the bottom of the tank;
subjecting the heavier molecular weight fulvic acid species to an osmosis process to give a fulvic acid concentrate containing from about 3-9% fulvic acid by volume;
mixing together said fulvic acid concentrate and said lower molecular weight species from said tank to give a product;
adding surfactant to said product; and
adding an amount of sodium chloride to said surfactant-added product.

23. The method of claim 22, said surfactant being a nonionic surfactant.

24. The method of claim 22, said acidic pH being from about 1.5-6.

25. The method of claim 22, said liquid herbicide being a ready-to-use product.

26. The method of claim 22, said liquid herbicide being a dilutable concentrate product.

27. A method of killing plants comprising the step of applying the herbicide of claim 1 to the plants, or to the earth adjacent the plants.

28. The method of claim 27, including the step of applying the herbicide to the leaves and/or stems of plants.
